(19) United States
(12) Patent Application Publication
(10) Pub. No.: US 2005/0045168 A1
(43) Pub. Date: Mar. 3, 2005

(54) Charcoal fire starter and cooking device

(76) Inventor: David Edwin Zapp, Columbus, OH (US)

Correspondence Address: Patrick P. Phillips;Kremblas, Foster, Phillips & Pollick, 7632 Slate Ridge Boulevard, Reynoldsburg, OH, 43068, US

(21) Appl. No.: 10/650,416

(22) Filed: Aug. 29, 2003

(51) Int. Cl. A47J 37/00

(52) U.S. Cl. 126/25 B; 126/25 R

(57) ABSTRACT

A briquette fire starter is provided having a first chamber, a second chamber and a cone. The first chamber has a sidewall, a top edge, and a bottom surface. the first chamber has a planar member disposed horizontally intermediate the top edge and the bottom surface. The planar member has at least one aperture formed therein. The sidewall has at least one aperture formed therein intermediate the bottom surface and the planar member. The second chamber is disposed in cooperating relationship with the first chamber. The second chamber has a sidewall, a top edge, and a bottom surface. The bottom surface of the second chamber has at least one aperture formed therein, with the bottom surface being able to have placed thereon a first fuel source and to have placed below a second fuel source. The second chamber bottom surface being located above the first chamber planar member. The cone is located above the first chamber planar member. Preferably the chambers are cylindrical.

### BACKGROUND OF THE INVENTION

1. Field of the Invention

The present invention relates generally to a portable fire starter, and more particularly to a charcoal fire starter, and even more particularly to a fire starter which can also be used as a cooker.

2. Description of the Related Art

This invention is directed to the providing of a portable fire starter which in the preferred embodiment of the invention uses charcoal, the structure of which efficaciously enhances the performance of the fuel used therein, and which device can also be used as a cooking device. The invention is also known as a charcoal chimney. Charcoal chimneys or fire starters have long been used by grilling aficionados who love to grill food on a barbeque grill.

For grilling purists, nothing can beat charcoal or a wood fire, especially if the fire is not contaminated by the use of a lighter fluid. There are two main reasons why some individuals do not care for using lighter fluids when it comes to grilling. The first reason is that it precludes flame burst, a condition which arises when lighter fluid is added to an already ignited fuel source in hope of quickening the combustion of the fuel source, thereby hastening the cooking process. Flame burst results when the added fluid itself undergoes combustion and either causes the can of lighter fluid to ignite, creating the potential for an extremely dangerous condition for the individual holding the can. Flame burst can also result when the fuel has an excessive amount of lighter fluid applied to it, such that when combustion occurs, the flame size is significantly greater than anticipated, creating the potential for an extremely dangerous condition for anyone positioned near the grill. One other advantage related to not using lighter fluid is economic, in that it incurs less cost.

One way to preclude the use of lighter fluid is to use a small quantity of ignited charcoal briquettes to ignite the other briquettes to be used in the cooking process. Conventional charcoal chimneys have been used to evenly heat other charcoal briquettes. Such devices are normally cylindrical, open at the top and the bottom, and have a plate extending across the interior of the cylinder. Charcoal is then placed on the plate and paper, such as newspaper, is placed under the plate and ignited, the idea being that the paper will cause the small amount of charcoal to ignite, and that after sufficient time has passed, the charcoal can be transferred to a grill where it can be distributed for the cooking process or placed in contact with a larger quantity of charcoal which in turn will ignite, thereby providing the fuel for cooking. Pouring lit charcoal from a chimney is also easier than trying to move individual briquettes by using tongs.

There are a couple of problems with existing charcoal chimneys which use paper as described above. Sometimes, the paper can be so compressed that it actually inhibits the updraft necessary to provide the initial heating of the briquettes. In some, the actual structure of the chimney can either make it difficult to easily light the kindling or readily permit the kindling to remain lit. Other times, there can be problems with the ash from the incinerated paper, perhaps the most common of which being the ash blowing onto nearby food.

In response to the desire to provide charcoal chimneys, numerous ones have been invented. Storandt, U.S. Pat. No. 3,974,821 discloses a charcoal fire starter and cooker with three main components. Kindling and charcoal is positioned in the bifurcated middle section. Frazier, U.S. Pat. No. 4,227,510 discloses a charcoal briquette lighter in the form of an upright container for the quick light starting of briquettes placed therein. There are two compartments, with the top having a handle and a base with holes, and the bottom having vented sides for draft.

Further, Karpinia, U.S. Pat. No. 4,417,565 discloses a unitary charcoal starter that is inwardly tapering, with an additional inwardly tapered structure located in the top section of the device. Gerson, U.S. Pat. No. 4,531,507 discloses a charcoal lighter device also of unitary construction featuring a panel which permits the charcoal to be dumped out when it is sufficiently heated.

Walton, U.S. Pat. No. 6,009,867 discloses an apparatus and method for charcoal ignition with the device having a thermal barrier movably attached to the top of the ignition chamber. Kent, U.S. Pat. No. 5,404,864 discloses an outdoor cooking system which is collapsible. It consists of a tube with a grate that is inserted from underneath the tube at its base, and a plurality of side panels which can form venting means. The bottom is essentially closed off. Pre-ignition takes place below the grate, and a fire chamber is located above the grate. Tessien, U.S. Pat. No. 5,197,455 discloses a unitary structure with a cone, with the structure having a grate intermediate the top and bottom of the starter.

While it is apparent that numerous attempts have been made to provide charcoal fire starters, problems with ash and inadequately heated coals remain. It is thus apparent that the need exists for a charcoal chimney which can effectively heat charcoal as well as diminish the problem associated with ash.

### SUMMARY OF THE INVENTION

In accordance with this invention a charcoal fire starter is provided having a first chamber and a second chamber. The first chamber has a sidewall, a top edge, and a bottom surface, with a planar member being disposed horizontally intermediate the top edge and the bottom surface. The planar member has at least one aperture formed therein, and the first chamber sidewall has at least one aperture formed therein intermediate the bottom surface and the planar member.

The second chamber is disposed in cooperating relationship with the first chamber. The second chamber has a sidewall, a top edge, and a bottom surface, with the bottom surface having at least one aperture formed therein. The second chamber has a cone atop its bottom surface, spaced inwardly of the second chamber sidewall. The second chamber bottom surface is located above the first chamber planar member.

The first chamber sidewall has retention means for support thereon of the planar member. In one embodiment, the planar member has formed therein a centrally positioned aperture. In one embodiment a plurality of planar members are directly adjacent to each other intermediate the top edge and the bottom surface, with each of such planar members having at least one aperture formed therein, so that the planar members are cooperatively adjusted relative to one another to facilitate control of the amount of air passing through the planar member.

The second chamber sidewall has a flange member, with the flange member forming the bottom edge of the sidewall. The flange member telescopes with the top edge of the first chamber. The second chamber has a removable grating placed atop the top edge of the second chamber. In at least one embodiment, the second chamber has attached thereto a handle.

In at least one embodiment, the second chamber has a plurality of supporting members extending downwardly from the second chamber bottom surface into contact with the first chamber planar member. The planar member is preferably removable from the first chamber. Preferably, the first chamber sidewall has apertures formed only on one side of the first chamber. In the preferred embodiment, the first and second chambers are cylindrical.

There is also disclosed a charcoal fire starter having a first chamber, a second chamber and a cone. The first chamber has a sidewall, a top edge, and a bottom surface, with a planar member disposed in the first chamber horizontally intermediate the top edge and the bottom surface. The planar member has at least one aperture formed therein, and the sidewall having at least one aperture formed therein intermediate the bottom surface and the planar member. The second chamber is disposed in cooperating relationship with the first chamber, and has a sidewall, a top edge, and a bottom surface, with the bottom surface having at least one aperture formed therein. The bottom surface is able to have placed thereon a first fuel source and to have placed below a second fuel source. The second chamber bottom surface is located above the first chamber planar member. The cone is located above the first chamber planar member.

The cone is located above the second chamber member bottom surface and spaced inwardly of the second chamber sidewall. In one embodiment, the cone is disposed in an intermediate chamber, with the intermediate chamber having a top edge and a bottom portion. The bottom portion has a bottom surface. The intermediate chamber top edge is in contact with the second chamber, and the intermediate chamber bottom portion is in contact with the first chamber, the cone resting on the intermediate member bottom surface. In one embodiment, the intermediate chamber has a plurality of supporting members extending downwardly therefrom. The first chamber sidewall preferably has apertures formed only on one side of the first chamber. The first and second chambers are preferably cylindrical, as is the intermediate chamber.

The primary objective of this invention is to provide a charcoal chimney which quickly and efficiently heats charcoal or other briquettes while at the same time eliminating the problems associated with prior art devices in terms of ash.

Another objective is to provide a charcoal fire starter that is of relatively economical construction and is relatively easy to fabricate. Still another objective is to provide a charcoal fire starter that is easy to use.

Other objects and advantages of the invention will be apparent from the following description, the accompanying drawings, and the appended claims.

### BRIEF DESCRIPTION OF THE DRAWINGS

FIG. 1 is a partially exploded side elevational view of a charcoal chimney made in accordance with the present invention.

FIG. 2 is a top plan view of the device of FIG. 1.

FIG. 3 is a vertical sectional view taken along line 3-3 of FIG. 2.

FIG. 4 is a vertical sectional view similar to FIG. 3, but of a first modified embodiment of the invention.

FIG. 5 is a top plan view of the device of FIG. 4.

FIG. 6 is a vertical sectional view similar to FIG. 3, but of a second modified embodiment of the invention.

FIG. 7 is a vertical sectional view similar to FIG. 3, but of a further modified embodiment of the invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

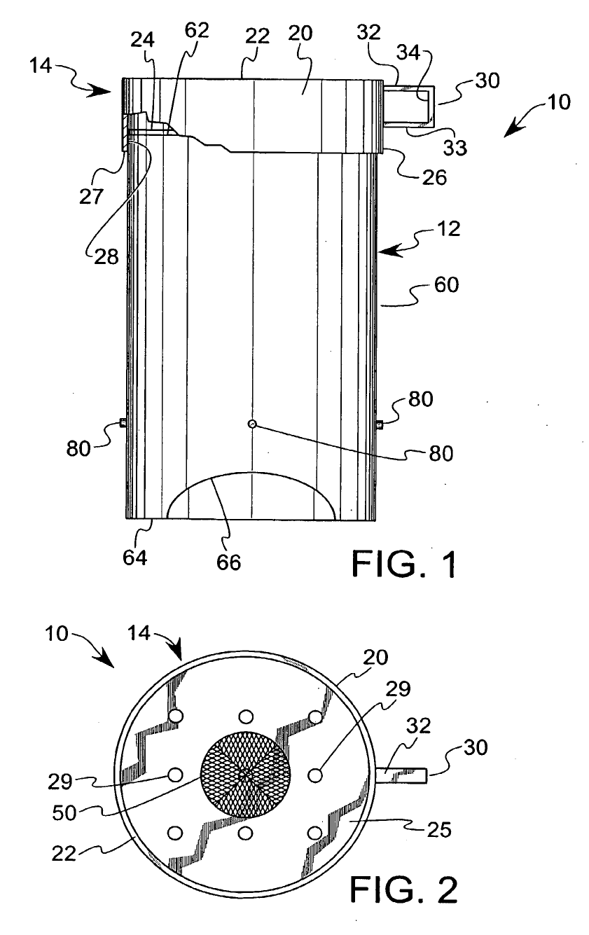

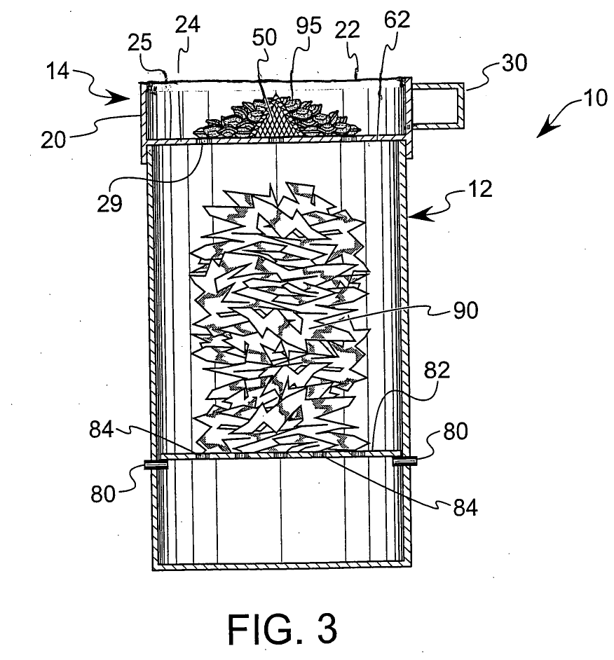

Having reference to the drawings, attention is directed first to FIG. 1 which discloses a charcoal briquette starter designated generally by the numeral 10, made in accordance with the present invention. The briquette starter 10 has as its two main components a combustion compartment 12 and a cup member 14. As can be appreciated from a comparison of FIGS. 1-3, the cup member 14 is shown as having a sidewall 20 having a top edge 22, and a bottom plate 24. This bottom plate 24 has a bottom plate top surface 25.

The cup member 14 and combustion chamber 12 have retaining means provided to prevent the cup member from too easily becoming dislodged from its position atop the combustion chamber. In the embodiment of the invention shown in FIGS. 1-3, the retaining means take the form of a flange 26 which extends downwardly at the bottom of the sidewall 20. This flange 26 has a bottom edge 27 and an interior surface 28. The inner diameter of the sidewall at the flange 26 is shown as being slightly greater than the outer diameter of the combustion chamber 12 at the point where the flange interior surface 28 is directly adjacent to the exterior sidewall of the combustion compartment.

Preferably the plate 24 is integral with the cup member 14, such that it is of planar sheet-form. However in the embodiment shown, there is at least one and more preferably a plurality of apertures 29 formed in the plate 24. Also shown as a preferred part of the cup member 14 is a handle 30. The handle has a top 32, a bottom 33, and an interior portion 34, although other handle configurations could be utilized.

Also shown in the cup member 14 is cone 50. The cone is of a height less than the height of sidewall 20. Further, the cone 50 rests on the top surface 25 of the bottom plate 24. The cone could be of a mesh substance, such as wire, or it could be formed from a sheet-form material having a plurality of apertures formed therein. In any case, the cone facilitates an updraft to enter the cone at its bottom or base, and rise in the interior of the cone until exiting through the apertures or openings in the cone sidewall.

Turning now to the combustion compartment 12, it will be readily appreciated as having a sidewall 60 with a top edge 62 and a bottom edge 64. There is also at least one sidewall opening 66. While in these drawing figures, the shape of the opening is shown as being an arch, other types of openings could be used such as holes or other geometrically configured openings. The sidewall opening or openings 66 in the lower portion of the combustion compartment sidewall only occur in one side of the combustion chamber, thus providing some degree of control of the air draft which can enter the device.

The Intermediate the top edge 62 and the bottom edge 64 is a holding means 80 which can support a combustion compartment bottom plate 82. The holding means 80 could be a plurality of pins inserted through the sidewall 60 or other structure such as spot welds upon which the bottom plate could rest or be secured. The bottom plate 82 features at least one, and preferably a plurality of bottom plate apertures 84. The purpose of these apertures is to allow the entry of air through the sidewall openings 66 to go up into the interior of the device.

The aforementioned sidewall opening 66 is located between the bottom plate 82 and the bottom edge 64. One of the purposes of the bottom edge 64 is to provide support for the device to rest on a surface, and to that end while the edge could in effect be just a rim on which the device rests, a comparison of these drawing figures discloses that there is a bottom surface which extends inwardly from the sidewall 60 so as to provide a planar surface of support.

In actual use, paper or other kindling 90 is placed into the first chamber 12. Charcoal or other types of briquettes 95 are placed around and on top of cone 50 in the second chamber 14. Once the paper is lit, air is drawn up through the bottom plate apertures 84 to feed that fire. The fire causes the charcoal to ignite, with the holes in the bottom plate 24 providing an updraft to quicken the time of ignition of the charcoal. If it is desired to transfer the charcoal into a larger grill structure, such as a conventional barbeque grill, the cup member 14 can be lifted off the combustion compartment 12 using handle 30, and the charcoal poured out onto the other grill.

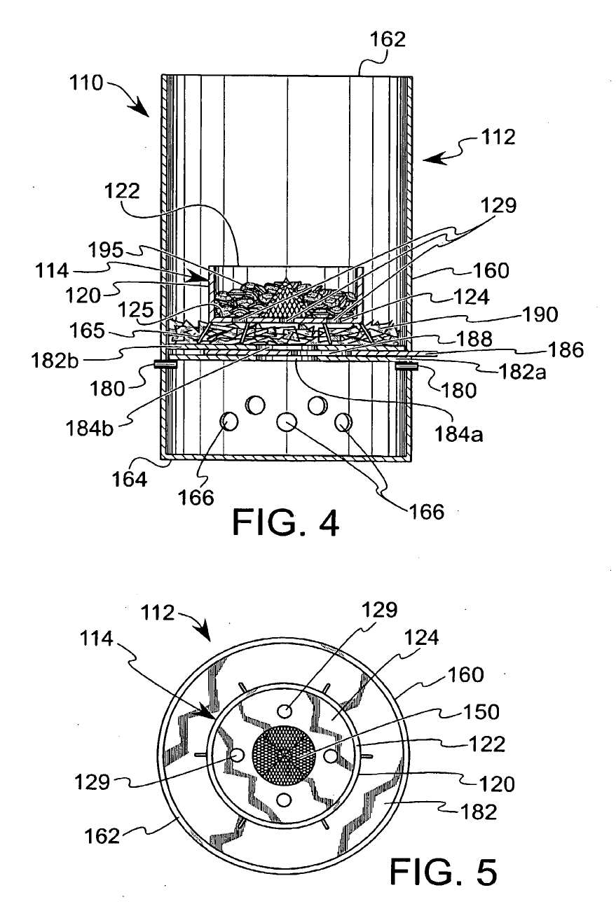

A first modified embodiment of the invention may be appreciated from a comparison of FIGS. 4-5. The briquette starter 110 of this embodiment also has as its two main components a combustion compartment 112 and a cup member 114. The cup member 114 is shown as having a sidewall 120 having a top edge 122, and a bottom plate 124. This bottom plate 124 has a bottom plate top surface 125.

The cup member 114 may optionally have a plurality of legs 165 extending downwardly from the bottom plate 124 for resting on the combustion chamber 112. The inner diameter of the sidewall of the combustion compartment is shown as being greater than the outer diameter of the cup member so that the cup can easily fit into the combustion compartment.

Preferably the plate 124 is integral with the cup member 114, such that it is of planar sheet-form. However in the embodiment shown, there is at least one centrally located aperture 120 formed in the plate, although alternatively a plurality of apertures 129 could be formed in the plate 124 as in the first disclosed embodiment.

Also shown in the cup member 114 is cone 150. The cone is of a height less than the height of sidewall 120. Further, the cone 150 rests on the top surface 125 of the bottom plate 124. The cone could be of a mesh substance, such as wire, or it could be formed from a sheet-form material having a plurality of apertures formed therein. In any case, the cone facilitates an updraft to enter the cone at its bottom or base, and rise in the interior of the cone until exiting through the apertures or openings in the cone sidewall.

Turning now to the combustion compartment 112, it will be readily appreciated as having a sidewall 160 with a top edge 162 and a bottom edge 164. There is also at least one sidewall opening 166, although in FIG. 4 a plurality of holes are shown as providing the sidewall opening. While in these drawing figures, a plurality of holes are used, other types of openings could be used such as the single arch shown in FIG. 1 or other geometrically configured openings. The sidewall opening or openings 166 in the lower portion of the combustion compartment sidewall preferably only occur in one side of the combustion chamber, thus providing some degree of control of the air draft which can enter the device.

Intermediate the top edge 162 and the bottom edge 164 is a holding means 180 which can support a combustion compartment bottom plate 182a. The holding means 180 could be a plurality of pins inserted through the sidewall 160 or other structure such as spot welds upon which the bottom plate could rest or be secured. The bottom plate 182a features at least one, and preferably a plurality of bottom plate apertures 184a. The purpose of these apertures is to allow the entry of air through the sidewall openings 166 to go up into the interior of the device.

Further control of the amount of air which passes through its bottom plate apertures 184a is effectuated by the use of a second bottom plate 182b located above the first bottom plate 182a and having the same orientation of bottom plate apertures 184b as bottom plate 182a. Intermediate the bottom plates 182a and 182b is a cooperating plate 186 with cooperating apertures 188. The cooperating plate 186 slides between the other two plates with adjustment provided by a projection 187 of the cooperating plate which extends through an opening 188 in the sidewall 160. The cooperating plate can be moved to obstruct the air flow or to maximize it.

The aforementioned sidewall opening 166 is located between the bottom plate 182a and the bottom edge 164. One of the purposes of the bottom edge 164 is to provide support for the device to rest on a surface, and to that end while the edge could in effect be just a rim on which the device rests, a comparison of these drawing figures discloses that there is a bottom surface which extends inwardly from the sidewall 160 so as to provide a planar surface of support.

In actual use, paper or other kindling 190 is placed into the first chamber 112 preferably on top of the bottom plate 184, but at least below the bottom of the second chamber 114. Charcoal or other types of briquettes 195 are placed around and on top of cone 150 in the second chamber 114. Once the paper is lit, air is drawn up through the bottom plate aperture 184 to feed that fire. The fire causes the charcoal to ignite, with the holes 129 in the bottom plate 124 providing an updraft to quicken the time of ignition of the charcoal. If it is desired to transfer the charcoal into a larger grill structure, such as a conventional barbeque grill, the cup member 114 can be removed from the combustion compartment 112 and the charcoal poured out onto the other grill.

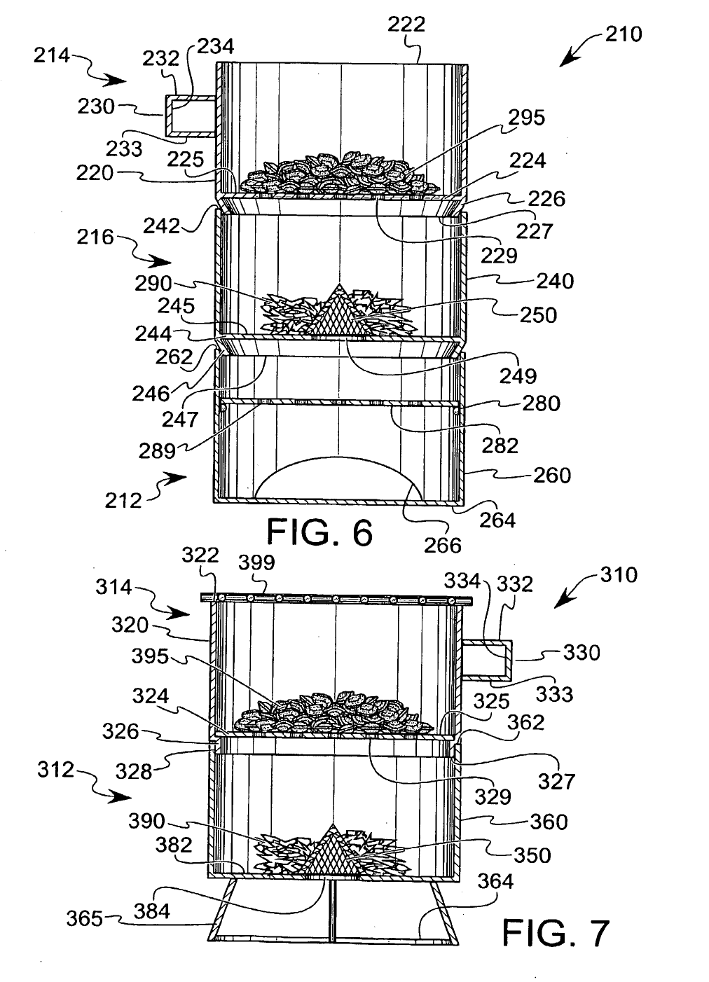

Yet another modified embodiment of a briquette starter 210 is shown in FIG. 6 has as its two main components a combustion compartment 212 and a cup member 214, with an intermediate member 216 therebetween. The cup member 214 is shown as having a sidewall 220 having a top edge 222, and a bottom plate 224. This bottom plate 224 has a bottom plate top surface 225.

The cup member 214 has retaining means provided to prevent the cup member from too easily becoming dislodged from its position atop the intermediate chamber 216. In the embodiment of the invention shown, the retaining means take the form of an inwardly bent flange 226 which extends downwardly and inwardly at the bottom of the sidewall 220. This flange 226 has a bottom edge 227 with the inner diameter of the intermediate chamber being slightly greater than the outer diameter of flange 226 at its bottom edge 227 at the point where the flange terminates inside the intermediate chamber.

Preferably the plate 224 is integral with the cup member 214, such that it is of planar sheet-form. However in the embodiment shown, there is at least one and more preferably a plurality of apertures 229 formed in the plate 224. Also shown as a preferred part of the cup member 214 is a handle 230. The handle has a top 232, a bottom 233, and an interior portion 234, although other handle configurations could be utilized.

The intermediate chamber 216 has a sidewall 240 having a top edge 242, and a bottom plate 244 having formed therein at least one aperture 249. On the top surface 245 of the bottom plate 244 rests cone 250. The cone is of a height less than the height of sidewall 240. The cone could be of a mesh substance, such as wire, or it could be formed from a sheet-form material having a plurality of apertures formed therein. In any case, the cone facilitates an updraft to enter the cone at its bottom or base, and rise in the interior of the cone until exiting through the apertures or openings in the cone sidewall.

The intermediate chamber 216 has retaining means provided to prevent it from too easily becoming dislodged from its position atop the combustion compartment 212. In the embodiment of the invention shown, the retaining means take the form of an inwardly bent flange 246 which extends downwardly and inwardly at the bottom of the sidewall 240. This flange 246 has a bottom edge 247 with the inner diameter of the intermediate chamber being slightly greater than the outer diameter of flange 246 at its bottom edge 247 at the point where the flange terminates inside the combustion chamber 212.

Turning now to the combustion compartment 212, it will be readily appreciated as having a sidewall 260 with a top edge 262 and a bottom edge 264. There is also at least one sidewall opening 266. While in these drawing figures, the shape of the opening is shown as being an arch, other types of openings could be used such as holes or other geometrically configured openings. The sidewall opening or openings 266 in the lower portion of the combustion compartment sidewall only occur in one side of the combustion chamber, thus providing some degree of control of the air draft which can enter the device.

Intermediate the top edge 262 and the bottom edge 264 is a holding means 280 which can support a combustion compartment bottom plate 282. The holding means could be a plurality of pins inserted through the sidewall 260 or other structure such the spot welds 280 shown, upon which the bottom plate could rest or be secured. The bottom plate 282 features at least one, and preferably a plurality of bottom plate apertures 289. The purpose of these apertures is to allow the entry of air through the sidewall opening 266 to go up into the interior of the device.

The aforementioned sidewall opening 266 is located between the bottom plate 282 and the bottom edge 264. One of the purposes of the bottom edge 264 is to provide support for the device to rest on a surface, and to that end while the edge could in effect be just a rim on which the device rests, a comparison of these drawing figures discloses that there is a bottom surface which extends inwardly from the sidewall 260 so as to provide a planar surface of support.

In actual use, charcoal or other types of briquettes 295 are placed above cone 250 in the second chamber 214. Paper or other kindling 290 is placed below the second chamber 212. Once the paper is lit, air is drawn up through the bottom plate apertures 289 to feed that fire. The fire causes the charcoal to ignite, with the holes 229 in the bottom plate 224 providing an updraft to quicken the time of ignition of the charcoal. If it is desired to transfer the charcoal into a larger grill structure, such as a conventional barbeque grill, the cup member 214 can be lifted off using handle 230, and the charcoal poured out onto the other grill.

Still another briquette starter 310 shown in FIG. 7 has as its two main components a combustion compartment 312 and a cup member 314. The cup member 314 is shown as having a sidewall 320 having a top edge 322, and a bottom plate 324. This bottom plate 324 has a bottom plate top surface 325.

The cup member 314 and combustion chamber 312 have retaining means provided to prevent the cup member from too easily becoming dislodged from its position atop the combustion chamber. In the embodiment of the invention shown in FIG. 7, the retaining means take the form of a flange 326 which extends downwardly at the bottom of the sidewall 320. This flange 326 has a bottom edge 327 and an interior surface 328. The outer diameter of the sidewall at the flange 326 is shown as being slightly less than the inner diameter of the combustion chamber 312 at the point where the flange exterior surface 328 is directly adjacent to the interior sidewall of the combustion compartment.

Preferably the plate 324 is integral with the cup member 314, such that it is of planar sheet-form. However in the embodiment shown, there is at least one and more preferably a plurality of apertures 329 formed in the plate 324. Also shown as a preferred part of the cup member 314 is a handle 330. The handle has a top 332, a bottom 333, and an interior portion 334, although other handle configurations could be utilized.

Turning now to the combustion compartment 312, it will be readily appreciated as having a sidewall 360 with a top edge 362 and a bottom edge 364, with a plurality of legs 365 extending downwardly from combustion compartment bottom plate 382 to the bottom 364 for resting on a surface. Intermediate the top edge 362 and the bottom edge 364 is a combustion compartment bottom plate 382. The bottom plate 382 features at least one aperture 384, if not more. The purpose of this aperture is to allow the entry of air from around the legs 365 to go up into the interior of the device.

Also shown in the combustion compartment 314 is cone 350. The cone is of a height less than the height of sidewall 360. Further, the cone 350 rests on the top surface of the combustion compartment bottom plate 382. The cone could be of a mesh substance, such as wire, or it could be formed from a sheet-form material having a plurality of apertures formed therein. In any case, the cone facilitates an updraft to enter the cone at its bottom or base, and rise in the interior of the cone until exiting through the apertures or openings in the cone sidewall.

In actual use, paper or other kindling 390 is placed into the first chamber 312. Charcoal or other types of briquettes 395 are placed above the cone 350 in the second chamber 314. Once the paper is lit, air is drawn up through the bottom plate apertures 384 to feed that fire. The fire causes the charcoal to ignite, with the holes in the bottom plate 324 providing an updraft to quicken the time of ignition of the charcoal. If it is desired to transfer the charcoal into a larger grill structure, such as a conventional barbeque grill, the cup member 314 can be lifted off the combustion compartment 312 using handle 330, and the charcoal poured out onto the other grill.

As a result of the characteristics of the structure of the invention, a charcoal briquette starter is provided which can efficiently enable the relatively quick ignition of briquettes while at the same time effectively eliminating the prior art problem associated with ash. This is due in part to the providing of a constant draft of non-turbulent air for the briquettes to facilitate the ignition of more surface area faster than most traditional charcoal chimneys. This results in a more consistent and more complete incineration of the kindling. Furthermore, a controlled draft is provided to simultaneously minimize, if not eliminate, the amount of ash able to be easily spilled from the starter. Ash is not blown out of the chimney easily. Conversely, it is retained in the chimney for easier disposal.

Moreover, the charcoal starter of this invention is of relatively economical construction and is relatively easy to fabricate. Also, it is safer inasmuch as the bottom surface remains cooler, thus reducing the risk of scorching and/or burning of any supporting surface on which it is used, such as a table, deck, porch, counter, or floor by way of example. Additionally, the device is easy to use and maintain. For example, it is easy to fill, light, pour, and clean.

While the form of apparatus herein described constitutes a preferred embodiment of the present invention, it is to be understood that the invention is not limited to this precise form of apparatus and that changes may be made therein without departing from the scope of the invention which is defined in the appended claims.

1. A charcoal fire starter comprising
a first chamber, said first chamber having a sidewall, a top edge, and a bottom surface, said first chamber having a planar plate member disposed horizontally intermediate said top edge and said bottom surface, said planar member having at least one aperture formed therein, said sidewall having at least one aperture formed therein intermediate said bottom surface and said planar member, and
a second chamber, said second chamber disposed in cooperating relationship with said first chamber, said second chamber having a sidewall, a top edge, and a bottom surface, said bottom surface having at least one aperture formed therein, said second chamber having a cone atop said bottom surface and spaced inwardly of said second chamber sidewall, said second chamber bottom surface located above said first chamber planar member.

2. The device according to claim 1 wherein said first chamber sidewall has retention means for support thereon of said planar member.

3. The device according to claim 1 wherein said planar member has formed therein a centrally positioned aperture.

4. The device according to claim 1 which includes a plurality of planar members directly adjacent to each other intermediate said first chamber top edge and said first chamber bottom surface, each of said planar members having at least one aperture formed therein, said planar members being cooperatively adjusted relative to one another to facilitate control of the amount of air passing through said apertures.

5. The device according to claim 1 wherein said second chamber sidewall has a flange member, said flange member forming the bottom edge of said sidewall, said flange member telescoping with said top edge of said first chamber.

6. The device according to claim 1 wherein said second chamber has a removable grating placed atop said top edge of said second chamber.

7. The device according to claim 1 wherein said second chamber has attached thereto a handle.

8. The device according to claim 1 wherein said second chamber has a plurality of supporting members extending downwardly from said second chamber bottom surface into contact with said first chamber planar member.

9. The device according to claim 1 wherein said planar member is removable from said first chamber.

10. The device according to claim 1 wherein said first chamber sidewall has apertures formed only on one side of said first chamber.

11. The device according to claim 1 wherein said first and second chambers are cylindrical.

12. A charcoal fire starter comprising
a first chamber, said first chamber having a sidewall, a top edge, and a bottom surface, said first chamber having a planar plate member disposed horizontally intermediate said top edge and said bottom surface, said planar member having at least one aperture formed therein, said sidewall having at least one aperture formed therein intermediate said bottom surface and said planar member,
a second chamber, said second chamber disposed in cooperating relationship with said first chamber, said second chamber having a sidewall, a top edge, and a bottom surface, said bottom surface having at least one aperture formed therein, said bottom surface being able to have placed thereon a first fuel source and to have placed below a second fuel source, said second chamber bottom surface located above said first chamber planar member, and
a cone, said cone located above said first chamber planar member.

13. The device according to claim 12 wherein said cone is located above said second chamber member bottom surface and spaced inwardly of said second chamber sidewall.

14. The device according to claim 12 wherein said cone is disposed in an intermediate chamber, said intermediate chamber having a top edge and a bottom portion, said bottom portion having a bottom surface, said top edge in contact with said second chamber, said intermediate chamber bottom portion in contact with said first chamber, said cone resting on said intermediate member bottom surface.

15. The device according to claim 14 wherein said intermediate chamber has a plurality of supporting members extending downwardly therefrom.

16. The device according to claim 12 wherein said first chamber sidewall has apertures formed only on one side of said first chamber.

17. The device according to claim 12 wherein said first and second chambers are cylindrical.

18. The device according to claim 14 wherein said intermediate chamber is cylindrical.
